(19) United States
(12) Patent Application Publication
(10) Pub. No.: US 2002/0102735 A1
(43) Pub. Date: Aug. 1, 2002

(54) Use of gradient mixtures for screening and optimization of catalysts for the production of condensation polymers

(75) Inventors: John Patrick Lemmon, Delanson, NY (US); Ronald James Wroczynski, Schenectady, NY (US); Oltea Puica Siclovan, Rexford, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/729,938

(22) Filed: Dec. 6, 2000

(51) Int. Cl. G01N 31/10

(52) U.S. Cl. 436/37

(57) ABSTRACT

A method of making and screening an array of catalysts, said method comprising: (a) combining a first polymerization precursor material, a second polymerization precursor material and a first catalyst in a first region on a substrate; (b) combining a first polymerization precursor material, a second polymerization precursor material and a second catalyst in a second region on a substrate; (c) reacting the first and second polymerization material in said first and second regions; and (d) screening said first and second regions of said substrate for a measurable property or properties.

### BACKGROUND OF THE INVENTION

This invention relates to a method for screening catalysts for the production of condensation polymers. More specifically, the present invention relates to a combinatorial method for screening an array of catalysts for the production of condensation polymers, particularly polycarbonates.

Combinatorial chemistry techniques have been developed by the pharmaceutical industry for the rapid development and screening of pharmaceutical compositions. For example, Pirrung et al. developed a technique for generating arrays of peptides and other molecules using, for example, light-directed, spatially-addressable synthesis techniques (U.S. Pat. No. 5,143,854). In addition, Fodor et al. have developed automated techniques for performing light-directed, spatially-addressable synthesis techniques, photosensitive protecting groups, masking techniques and methods for gathering fluorescence intensity data (Fodor et al., PCT Publication No. WO 92/10092).

Combinatorial chemistry has also been applied in the search for novel and highly active catalysts that promote commercially significant reactions. U.S. Pat. No. 6,030,917 describes methods for the combinatorial synthesis, screening and characterization of libraries of supported and unsupported organometallic compounds. The invention disclosed therein is directed primarily to the development of catalysts that promote olefin polymerization.

U.S. Pat. Nos. 6,034,240 and 6,043,363 disclose a combinatorial approach to the development of novel ligands for organometallic complexes that are catalysts for polymerization reactions.

Published PCT Application WO 00/20377 discloses, inter alia, combinatorial techniques used to develop ligands and compositions containing those ligands. Described therein are compositions that catalyze olefin polymerization reactions.

Published PCT Application WO 97/32208 discloses methods and apparatus for the testing of catalysts.

The above patents contain examples of the applicability of combinatorial chemistry in the development of novel catalysts. However, the aforementioned patents do not describe the use of combinatorial chemistry for the development of novel catalysts specifically aimed at the production of condensation polymers, especially polycarbonates. Polycarbonates, of course, are a commercially significant member of a select group of engineering thermoplastics that have found applications to replace metals and glass where its strength and optical properties are important.

Catalysts for the production of condensation polymers, including polycarbonates are known in the art (see U.S. Pat. Nos. 5,717,057; 5,606,008; 5,606,007; 5,468,836; 5,362,840; 5,340,905; 5,319,066; 5,026,817; 5,306,801; 5,025,083; 5,149,770; 5,168,112; 5,717,057; 5,373,083; 5,097,002; 5,250,655; 5,319,066; 5,340,905; 5,151,491; 5,286,834; 5,288,838; 5,527,875). However, these patents do not describe a combinatorial approach for the development of novel catalysts.

### SUMMARY OF INVENTION

One preferred embodiment of the present invention relates generally to a method of making and screening an array of catalysts, said method comprising:

(a) combining a first polymerization precursor material, a second polymerization precursor material and a first catalyst in a first region on a substrate;

(b) combining a first polymerization precursor material, a second polymerization precursor material and a second catalyst in a second region on a substrate;

(c) reacting the first and second polymerization material in said first and second regions; and

(d) screening said first and second regions of said substrate for a measurable property or properties.

More specifically, another preferred embodiment of the present invention relates to a method of making and screening an array of catalysts, said method comprising:

(a) combining a bisphenol compound, a diester of carbonic acid and a first metal-containing catalyst in a first region of a substrate;

(b) a bisphenol compound, a diester of carbonic acid and a second metal-containing catalyst in a second region on a substrate;

(c) reacting a bisphenol compound and a diester of carbonic acid in said first and second regions; and

(d) screening said first and second regions of said substrate for a measurable property or properties.

The most preferred embodiment of the present invention relates to a method of making and screening an array of catalysts, said method comprising:

(a) combining bisphenol A, diphenylcarbonate and a first metal containing catalyst in a first region of a substrate;

(b) bisphenol A, diphenylcarbonate and a second metal-containing catalyst in a second region on a substrate;

(c) reacting bisphenol A and a diphenylcarbonate in said first and second regions; and

(d) screening said first and second regions of said substrate for a measurable property or properties.

### BRIEF DESCRIPTION OF THE DRAWINGS

FIG. 1A shows a side view of a substrate into which two different reagents are being added via a dispenser to two different regions, A and B, on the substrate.

FIG. 1B shows a side view of a substrate into which two different reagents are being added via a dispenser to each of two regions, A and B, on the substrate.

FIG. 2 shows a schematic representation of a substrate containing an array of catalysts that contain up to three components.

FIG. 3 shows a top view of an array of catalysts on a substrate.

FIG. 4 shows a schematic representation of substrates each containing an array of catalysts that contain up to three components.

FIG. 5 shows results from the screening of a catalyst library.

FIG. 6 shows a multi-detector, high throughput liquid chromatography apparatus. A multi-well robot is used to inject polymer samples on to a custom-made size exclusion column. Molecular weight is determined by the use of a combination light scattering/viscosity detector and the Fries rearrangement is quantified using a in-line fluorescence detector. The refractive index detector is used for normalization of the fluorescence signal.

### DETAILED DESCRIPTION OF THE PREFERRED EMBODIMENTS

From the forgoing discussion, it is apparent that there is a need for a method that will facilitate and accelerate the discovery of catalysts for the production of polycarbonates that are free of the shortcomings of known catalysts. The inventors have realized that combinatorial chemistry can be used to quickly develop optimized catalysts for the efficient production of polycarbonates.

The preferred embodiments of the present invention provide a method for the preparation and use of a substrate having an array of catalysts in predefined regions thereon. The method is described herein primarily with regard to the preparation of inorganic catalysts, but can readily be applied in the preparation of other catalysts. Catalysts which can be prepared in accordance with the methods of the preferred embodiments of the present invention include, for example, organic catalysts and organometallic catalysts, or other catalysts which will be apparent to those of skill in the art.

The resulting substrate having an array of catalysts and polymerization precursors thereon has a variety of uses. For example, the substrate can be screened for catalysts having useful properties by screening the substrate and/or reaction for a measurable property or properties (e.g., fluorescent response). Accordingly, the array of catalysts is preferably synthesized on a single substrate. By synthesizing the array of catalysts on a single substrate, screening the array for a measurable property or properties is more easily carried out.

Properties which can be screened for include, for example, electrical, thermal, mechanical, morphological, optical, magnetic, chemical, etc. More particularly, properties which can be screened for include, for example, molecular weight, conductivity, resistivity, thermal conductivity, anisotropy, hardness, crystallinity, optical transparency, photoemission, or other measurable properties which will be apparent to those of skill in the art. Importantly, the synthesis and screening of a diverse array of catalysts enables the development of new catalysts with useful properties. Any catalyst found to possess a useful property can be subsequently prepared on a large-scale. It will be apparent to those of skill in the art that once identified using the methods of the preferred embodiments of the present invention, a variety of different methods can be used to prepare such useful catalysts on a large or bulk scale with essentially the same structure and properties.

Preferably, the array of catalysts is prepared by successively delivering components of the catalyst, along with other reagents (e.g., monomers, when the reaction sought to be promoted is a polymerization reaction), to predefined regions on a substrate, and simultaneously reacting the reagents to form at least one new material. In one embodiment, for example, a first polymerization precursor material, a second polymerization precursor material and a first catalyst are combined in a first region on a substrate. Then, a first polymerization precursor material, a second polymerization precursor material and a second catalyst are combined in a second region on a substrate. Each component of the catalyst can be delivered in either a uniform or gradient fashion to produce either a single stoichiometry or, alternatively, a large number of stoichiometries within predefined regions on the substrate. As explained below, the components of the catalyst can be sequentially or simultaneously delivered to predefined regions on the substrate using any of a number of different delivery techniques.

In the delivery systems of the preferred embodiments of the present invention, a small, precisely metered amount of each reagent component is delivered into each reaction region. This may be accomplished using a variety of delivery techniques. The various reagents can be deposited into the reaction regions of interest from a dispenser in the form of droplets. Conventional micropipetting apparatus can, for example, be adapted to dispense droplet volumes of 5 nanoliters or smaller from a capillary. The dispenser can also be of the type employed in conventional ink-jet printers. Such ink-jet dispenser systems include, for example, the pulse pressure type dispenser system, the bubble jet type dispenser system and the slit jet type dispenser system. These ink-jet dispenser systems are able to deliver droplet volumes as small as 5 picoliters. Such dispenser systems can be manual or, alternatively, they can be automated using, for example, robotics techniques. Moreover, the dispenser can be aligned with respect to the appropriate reaction regions by a variety of conventional systems. The position of the dispenser stage of such systems can be calibrated with respect to the position of the substrate by a variety of methods known in the art.

In a preferred embodiment an array of diverse catalysts is prepared at known locations on a single substrate surface. Essentially, any conceivable substrate can be used. The substrate can be organic, inorganic, biological, nonbiological, or a combination of any of these, existing as particles, strands, precipitates, gels, sheets, tubing, spheres, containers, capillaries, pads, slices, films, plates, slides, etc. The substrate can have any convenient shape, such a disc, square, sphere, circle, etc. The substrate is preferably an array of containers, such as dimples on the top side of the substrate or containers which may protrude above the surface of the substrate, but may take on a variety of alternative configurations. The invention requires that there are at least two containers that compose the substrate. However, the substrate can contain from 2 to 400 containers, more preferably, 50 to 100 containers.

When the substrate comprises containers, the volume of the container(s) may range from about 1 microliter to about 500 microliters, more preferably from 10 to 200 microliters, most preferably from 25 to 100 microliters.

The substrate preferably forms a rigid support on which to carry out the reaction described herein. The substrate may be any of a wide variety of materials including, for example, polymers, pyrex, quartz, resins, silicon, silica or silica-based materials, carbon, metals, ceramics, inorganic glasses, inorganic crystals, membranes, etc. Other substrate materials will be readily apparent to those of skill in the art. Surfaces on the substrate can be composed of the same materials as the substrate or, alternatively, they can be different, i.e., the substrates can be coated with a different material. Moreover, the substrate surface can contain thereon an adsorbent (for example, cellulose) to which the components of interest are delivered. The most appropriate substrate and substrate-surface materials will depend on the class of materials to be synthesized and the selection in any given case will be readily apparent to those of skill in the art. An example of a commonly used substrate is a 96 well microtiter plate; although not all 96 wells need to be used.

When the substrate is flat, regardless of the configuration of the substrate surface, it is imperative that the reagents in the individual reaction regions be prevented from moving to adjacent reaction regions. Most simply, this can be ensured by leaving a sufficient amount of space between the regions on the substrate so that the various components cannot interdiffuse between reaction regions. Moreover, this can be ensured by providing an appropriate barrier between the various reaction regions on the substrate. A physical structure can be used to define the various regions on the substrate. For example, a wall or other physical barrier can be used to prevent the reagents in the individual reaction regions from moving to adjacent reaction regions. Alternatively, a dimple or other recess can be used to prevent the reagents in the individual reaction regions from moving to adjacent reaction regions.

If the substrate used in the preferred embodiments of the present invention is to contain dimples or other recesses, the dimples must be sufficiently small to allow close packing on the substrate. It should be noted, however, that the separation and depth of the dimples is important insofar as both are sufficient to prevent the interdiffusion of reagents from one region on the substrate to another.

In the delivery systems of the preferred embodiments of the present invention, a small, precisely metered amount of each reagent is delivered into each reaction region. This may be accomplished by using a dispenser. Dispensers can be utilized to generate diverse combinations of reagents in the form of droplets or powder on a single substrate. Commercially available micropipetting apparatus can be adapted to dispense droplet volumes of 5 nanoliters or smaller from a capillary. The micropipette is accurately and precisely positioned above the reaction, as described below, before the reagent solution is deposited. In a preferred embodiment, reagents may be delivered in sequential order from a single pipette or simultaneously from a plurality of pipettes.

The dispenser used in the preferred embodiments of the present invention may be any one of those known in the art. The reagents may be dispensed onto the substrate from a standard microliter pipette manually or with the use of robotics. Alternatively, a solution depositing apparatus that resembles devices commonly employed in the ink-jet printing field may be used. Such inkjet dispensers are well known in the art (see U.S. Pat. No. 5,985,356). Such ink-jet printers can be used with minor modification by simply substituting a reagent containing solution or reagent containing powder for the ink.

Using the aforementioned dispenser systems, the reagents can be delivered to predefined regions on the substrate either sequentially or simultaneously. In a preferred embodiment, the reagents may be delivered by the following method wherein:

Step (a) comprises:

(i) delivering the first catalyst to the first region on the substrate;

(ii) delivering the first polymerization precursor material and the second polymerization precursor material to said first region on the substrate; and

wherein step (b) comprises:

(i) delivering the second catalyst to said second region on the substrate; and

(ii) delivering the first polymerization precursor material and the second polymerization precursor material to said second region on a substrate.

Preferably, step (a) occurs before step (b). Alternatively, step (a) and step (b) are performed at the same time by using a plurality of pipettes. Thus, within each step, (a) and (b), the reagents may be delivered as follows:

(i) the first polymerization precursor material and the second polymerization precursor material may be delivered before the catalyst;

(ii) the first polymerization precursor material and the second polymerization precursor material may be delivered after the catalyst;

(iii) the first polymerization precursor material and the second polymerization precursor material may be mixed prior to delivery and may be delivered before or after the catalyst;

(iv) the first polymerization precursor material and the catalyst are mixed prior to being delivered and are delivered before the second polymerization precursor material;

(v) the second polymerization precursor material and the catalyst are mixed prior to being delivered and are delivered before the first polymerization precursor material; and

(vi) the first polymerization precursor material is delivered before the catalyst and then the second polymerization precursor material is delivered.

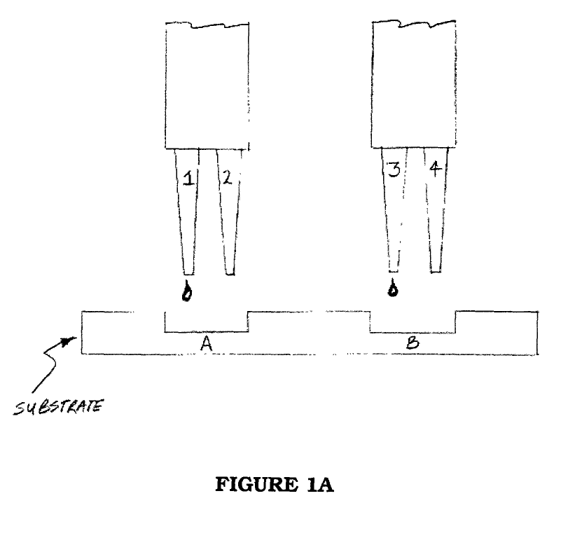

For example, using two or more micropipettes or a robot having two or more micropipettes, two or more different reagents or catalysts can be simultaneously delivered to a single predefined region on the substrate. Alternatively, a reagent or catalyst can be simultaneously delivered to two different predefined regions on the substrate. In this instance, the same reagent or catalyst or, alternatively, two different reagents or catalysts can be delivered. The delivery of the same reagent or catalyst or two different reagents or catalysts to two different regions on the substrate may be accomplished by positioning two sets of micropipettes over the desired regions on the substrate as shown in FIGS. 1A & 1B. Referring to FIG. 1A: when only one reagent or catalyst is delivered to two different regions on the substrate, micropipettes 1 and 3 would deliver the reagents or catalysts simultaneously to regions A and B, respectively. When two different reagents or catalysts are delivered to two different regions on the substrate (FIG. 1B), micropipettes 1 and 2 would deliver the reagents or catalysts to region A, while micropipettes 3 and 4 would deliver reagents or catalysts to region B. If the same reagent or catalyst is delivered to both of the predefined regions, it can be delivered at either the same or different concentrations.

It should be noted that the first and second polymerization precursor materials do not react significantly with each other in the absence of the catalyst, nor does each polymerization precursor material react with itself in the presence of the catalyst. Therefore, when the two polymerization precursor materials are mixed prior to being delivered to the substrate, they do not react significantly until the catalyst is dispensed into the region on the substrate containing the mixture of the polymerization precursor materials. Likewise, when the catalyst is mixed with one of the polymerization precursor materials, no reaction takes place until the second polymerization precursor material is dispensed into the region containing the mixture of first polymerization precursor material and the catalyst.

In a preferred embodiment, one polymerization precursor material (e.g., first polymerization precursor material) includes bishydroxy compounds of the Formula (I):

HO—D—OH (I)

wherein D is a divalent aromatic radical. Preferably, D has the structure of formula II;

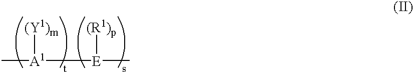

Wherein

A represents an aromatic group such as phenylene, biphenylene, naphthylene, etc.

E may be an alkylene or alkylidene group such as methylene, ethylene, ethylidene, propylene, propylidene, isopropylidene, butylene, butylidene, isobutylidene, amylene, amylidene, isoamylidene, etc.; where E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon-containing linkage; or a sulfur-containing linkage such as sulfide, sulfoxide, sulfone, etc.; or a phosphorus-containing linkage such as phosphinyl, phosphonyl, etc.

In addition, E may be a cycloaliphatic group (e.g., cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, etc.); a sulfur-containing linkage, such as sulfide, sulfoxide or sulfone; a phosphorus-containing linkage, such as phosphinyl, phosphonyl; an ether linkage; a carbonyl group; a tertiary nitrogen group; or a silicon-containing linkage such as silane or siloxy. R¹ represents hydrogen or a monovalent hydrocarbon group such as alkyl, aryl, aralkyl, alkaryl, or cycloalkyl.

Y¹ may be an inorganic atom such as halogen (fluorine, bromine, chlorine, iodine); an inorganic group such as nitro; an organic group, or an oxy group such as OR; it being only necessary that Y¹ be inert to and unaffected by the reactants and reaction conditions used to prepare the polycarbonate.

The letter m represents any integer from and including zero through the number of positions on A¹ available for substitution; p represents an integer from and including zero through the number of positions on E available for substitution; t represents an integer equal to at least one; s is either zero or one; and u represents any integer including zero.

In the bishydroxy compound in which D is represented by formula II above, when more than one Y substituent is present, they may be the same or different. The same holds true for the R¹ substituent. Where s is zero in formula II and u is not zero, the aromatic rings are directly joined with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups.

Some illustrative, non-limiting examples of dihydric phenols of formula I include the dihydroxy-substituted aromatic hydrocarbons disclosed by name or formula (generic or specific) in U.S. Pat. No. 4,217,438, which is incorporated herein by reference. Some preferred examples of dihydric phenols include 4,4′-(3,3,5-trimethylcyclohexylidene)diphenol; 2,2-bis(4-hydroxyphenyl)propane (commonly known as bisphenol-A); 2,2-bis(4-hydroxy-3,5-dimethylphenyl)propane; 2,4′-dihyroxydiphenylmethane; bis(2-hydroxyphenyl)methane; bis (4-hydroxy-phenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)-propane; bis(4-hydroxyphenyl)cyclohexylmethane; 2,2-bis(4-hydroxyphenyl)-1-phenylpropane; resorcinol; C₁₋₃ alkyl-substituted resorcinols.

Suitable bishydroxy compounds also include those containing spirobiindane structural units such as represented by the formula III:

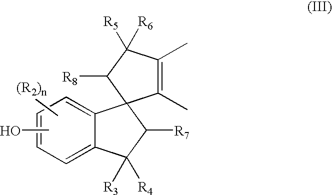

Wherein each R₂ is independently selected from monovalent hydrocarbon radicals and halogen radicals; each R₃, R₄, R₅, and R₆ is independently C₁₋₆ alkyl; each R₇ and R₈ is independently H or C₁₋₆ alkyl; and each n is independently selected from positive integers having a value of from 0 to 3 inclusive. The monovalent hydrocarbon radicals represented by R₂ include alkyl radicals, cycloalkyl radicals, aryl radicals, aralkyl radicals, and alkaryl radicals. Alkyl radicals represented by R₂ are preferably those containing from 1 to about 12 carbon atoms, and include branched alkyl radicals and straight chain alkyl radicals. Some illustrative non-limiting examples of these alkyl radicals include methyl, ethyl, propyl, isopropyl, butyl, tertiary-butyl, pentyl, neopentyl, and hexyl.

Cycloalkyl radicals represented by R₂ are preferably those containing from 3 to about 12 ring carbon atoms. Some illustrative non-limiting examples of these cycloalkyl radicals include cyclobutyl, cyclopentyl, cyclohexyl, methylcyclohexyl, cycloheptyl.

Aryl radicals represented by R₂ are preferably those containing from 6 to 12 ring carbon atoms. Some illustrative non-limiting examples of these aryl radicals include phenyl, biphenyl, naphthyl. Preferred aralkyl and alkaryl radicals represented by R₂ are those containing from 7 to about 14 carbon atoms. These include, but are not limited to, benzyl, ethylphenyl, phenylbutyl, phenylpropyl, propylphenyl, and phenylethyl. The preferred halogen radicals represented by R₂ are fluorine, chlorine and bromine.

In the dihydric phenol compound of formula III when more than one R₂ substituent is present they may be the same or different. The relative positions of the hydroxyl groups and R₂ on the aromatic nuclear residues may be varied in the ortho or meta positions. The position of each hydroxy group is independently at any unsubstituted site on each of the aromatic rings. More preferably each hydroxy group is independently in positions 5 or 6 and 5′ or 6′ of each aromatic ring. Most preferably each hydroxy group is in position 6 and 6′ of each aromatic ring.

Preferably, each R₂ is independently selected from chlorine, bromine, and lower alkyl radicals containing from I to about 5 carbon atoms, each R₃, R₄, R₅, and R₆ is independently C₁₋₆ alkyl; each R₇ and R₈ is independently H or C₁₋₆ alkyl; and each n is independently 0 to 3. More preferably, each R₂ is independently selected from chlorine and lower alkyl radicals containing from 1 to about 3 carbon atoms, each R₃, R₄, R₅, and R₆ is independently C₁₋₂ alkyl; each R₇ and R₈ is independently H or C₁₋₂ alkyl; and each n is independently 0 to 2. Still more preferably, each R₃, R₄, R₅, and R₆ is methyl; each R₇ and R₈ is H; and each n is 0.

The spiro dihydric phenols of formula Ell are compounds that are known in the art and are commercially available or may be readily prepared by known methods. Methods of preparation include those described in U. S. Pat. No. 4,701,566; Curtis and Lewis, J. Chem. Soc.: 420 (1962); and Curtis J. Chem. Soc.:

417 (1962). In one illustrative, non-limiting example these Spiro dihydric phenols may be conveniently prepared by (i) reacting two moles of a phenolic compound with one mole of a carbonyl-containing compound such as acetone, and (ii) thereafter coreacting 3 moles of the product of (i) under acidic conditions to form the Spiro dihydric phenol and 4 moles of a phenolic compound. The acids which may be utilized in (ii) can include such acids as anhydrous methane sulfonic acid, anhydrous hydrochloric acid, and the like.

The most preferred spiro dihydric phenol for forming polycarbonates suitable for use in the present invention is 6,6′-dihydroxy-3,3,3′,3′-tetramethyl-1,1′-spirobiindane (SBI), in which n in formula III is 0 and the linkages with the rest of the polymer molecule are in a specific position on the aromatic rings.

The dihydroxy compounds described above may be used alone or as mixtures of two or more different dihydoxy compounds. For reasons of availability and particular suitability for the purposes of this invention, a preferred dihydoxy compound is 2,2-bis(4-hydroxyphenyl)propane (bisphenol-A or BPA), in which D in formula II is bis(4-phenyl) isopropylidene.

The other polymerization precursor material (e.g., second polymerization precursor material) includes diesters of carbonic acid of the formula (IV):

R₉—O—C(O)—O—R₁₀ (IV)

Wherein each R₉ and R₁₀ may be the same or different and may be an aryl group, a C₁₋₁₈ alkyl group, or an alkylaryl group. Suitable diesters of carbonic acid include, but are not limited to, diphenyl carbonate; bis(4-t-butylphenyl)carbonate; bis(2,4-dichlorophenyl)carbonate; bis(2,4,6-trichloro-phenyl)carbonate; bis(2-cyanophenyl)carbonate; bis(o-nitrophenyl)carbonate; ditolyl carbonate; m-cresol carbonate; dinaphthyl carbonate; bis-(diphenyl)carbonate; diethylcarbonate; dimethyl carbonate; dibutyl carbonate; dicyclohexyl carbonate; and mixtures thereof. Of these, diphenyl carbonate is preferred. If two or more of these compound are utilized, it is preferable that one is diphenyl carbonate.

Most preferably, the carbonate of the present invention is diphenylcarbonate.

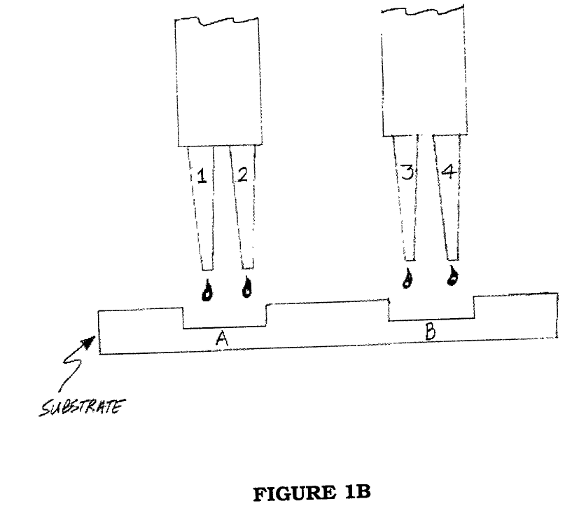

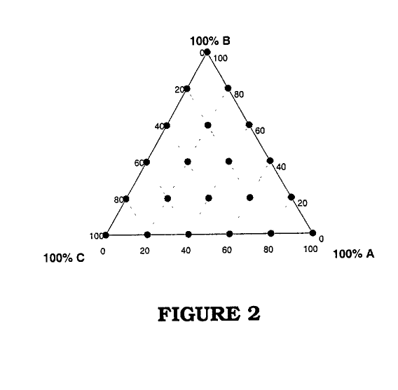

The catalysts that are being screened for the propensity for polymerization of the first polymerization precursor with the second polymerization precursor comprise one or more metal salts of differing stoichiometries or composition. In a preferred embodiment, the catalyst comprises 1-3 metal salts. Examples include salts of the alkali and alkaline earth metals such as the hydroxides LiOH, NaOH, KOH, RbOH and CsOH, Mg(OH)₂, Ca(OH)₂, Sr(OH)₂, and Ba(OH)₂ and transition metal complexes such as the acetylacetonates, acetates, triflates, or nitrates of copper, cobalt, palladium, platinum, manganese, chromium, zirconium, and iron, as well as complex metal salts or mixtures thereof. Examples of complex metal salts such include, but are not limited to, CaNa₂EDTA, CaNa₂EDTA, CuNa₂EDTA, MgK₂EDTA, MnNa₂EDTA, Na₂CuEDTA, Na₂MnEDTA, Na₂MoO₄, Na₂NiEDTA, Na₃VO₄ and ZnNa₂EDTA. The concentration of metal salts that comprise the catalysts in the preferred embodiments of the present invention may be from about 1×10⁻⁵ M to about 1×10⁻³ M, most preferably from 1×10⁻⁴ M to 1×10⁻³ M It must be noted that when two or more metal salts comprise the catalyst within a given region on the substrate, the concentration of each metal salt may vary within the aforementioned ranges such that an array of catalysts may be obtained. This concept is best illustrated generally for a catalyst that may contain up to three components, A, B and C (i.e., three metal salts) as shown in FIG. 2. In an embodiment, (see FIG. 3), A, B and C are NaOH, CsOH and LiOH, respectively. Additionally, the catalysts of the preferred embodiments of the present invention may further comprise an organic co-catalyst. A non-limiting example of an organic co-catalyst is tetramethyl ammonium hydroxide.

FIG. 3 shows a gradient array of catalysts on a substrate. The substrate is prepared by delivering stock solutions of each component of the catalyst to each of the locations on the substrate of FIG. 3. As one goes along the line that leads from 100% NaOH to 100% CsOH, the composition of the catalyst changes gradually so that the catalyst comprises an intermediate percentage of NaOH and CsOH. The same holds true for the lines between NaOH and LiOH and CsOH and LiOH. Naturally, in the middle of the triangle, the catalyst comprises an intermediate percentage of each of NaOH, CsOH and LiOH, thus creating an array of catalysts on the substrate. So, for example, at location C3, C4 on FIG. 3, the catalyst is comprised of LiOH, NaOH and CsOH in a molar ratio of 2:1:2. At location D1,D2, however, the catalyst is comprised LiOH, NaOH and CsOH in a molar ratio of 2:2:1. The methods of the embodiments of the present invention present the opportunity to effectively run twenty-one reactions simultaneously following addition of the polymerization precursor materials; that is, of course, assuming that the concentration of metal salts are increased by 20% from location to location as show in FIG. 2. Screening for a measurable property or properties is then performed on the following: on the substrate, the reaction in question, the product(s) resulting from the reaction or side reactions.

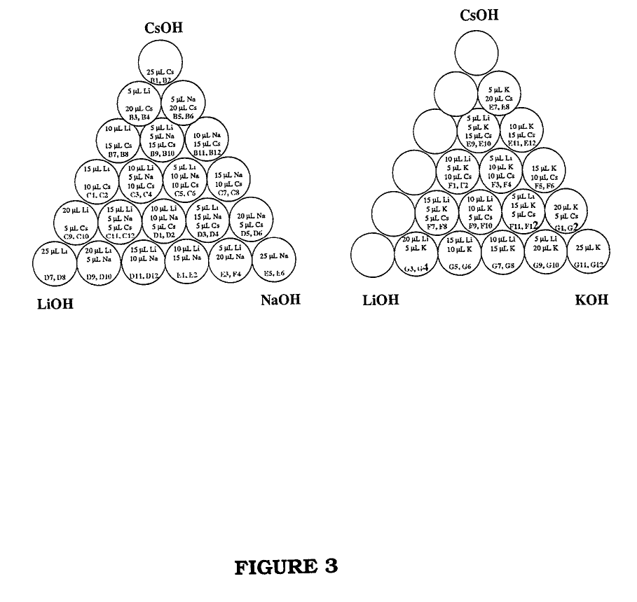

The present invention is not restricted to screening a catalyst that is comprised of only one set of three components. FIG. 4 illustrates how the present invention may be adapted to screen for a catalyst that comprises multiple sets of three metal salts. By using such an array, effectively 84 reactions may be run simultaneously that produce all of the necessary combinations to evaluate the full array of all three at a time combinations possible with four different metal salts. That is, of course, assuming that the concentration of alkali metal hydroxide is increased by 20% from location to location as show in FIG. 4. It should be noted that the four triangles shown in FIG. 4 may represent four different substrates or one single substrate. One may imagine combining the triangles in FIG. 4 to make a single substrate by effectively “joining” each triangle by a side that each has in common. For example, the ABC and the BCD triangles may be “joined” along the BC line. The resulting ABDC parallelogram may then be “joined” to the ADC triangle along the DC line, and so on. In an embodiment, A, B, C and D are NaOH, CsOH, LiOH and KOH, respectively.

The reaction temperature is from about 30 to 500° C., most preferably, the reaction temperature is from 280° C. to 310° C.

The reaction may be carried out for about 0.25 to 5.0 hours, preferably, about 1.0 to 1.5 hours.

Once the array of components have been delivered to predefined regions on the substrate, they can be simultaneously reacted using a number of different synthetic methods. The components can be reacted using, for example, solution based synthesis techniques, photochemical techniques, polymerization techniques, template directed synthesis techniques, by thermal, infrared or microwave heating, by hydrothermal methods, etc. Other useful synthesis techniques will be apparent to those of skill in the art. Moreover, the most appropriate synthetic method will depend on the class of materials to be synthesized, and the selection in any given case will be readily apparent to those of skill in the art. In addition, it will be readily apparent to those of skill in the art that, if necessary, the reagents can be mixed using, for example, ultrasonic techniques, mechanical techniques, etc. Such techniques can be applied directly to a given predefined region on the substrate or, alternatively, to all of the predefined regions on the substrate in a simultaneous fashion (e.g., the substrate can be mechanically moved in a manner such that the components are effectively mixed).

Moreover, using the various synthetic methods of the preferred embodiments of the present invention, the array of reagents can be pressurized or depressurized under an inert atmosphere, oxygen or other gas. In addition, in the synthetic methods of the present invention, various regions on the substrate can be exposed to different heat histories using, for example, laser thermolysis, wherein bursts of energy of a predetermined duration and intensity are delivered to target regions on the substrate.

As such, using the methods of the preferred embodiments of the present invention, can be used to prepare, organic polymers, namely polycarbonates, by delivering a first and/or second polymerization precursor material (hereinafter known as monomer or monomers) of interest to predefined regions on the substrate in the form of a solution or neat (i.e., not dissolved in a solvent). Monomers, as used herein, is meant to also embrace oligmers that may be polymerized and thus be used as building blocks for polymers. Once the monomer or monomers of interest have been delivered, an initiator or catalyst (i.e., a metal salt) is added to each region on the substrate. As mentioned previously, the monomer or monomers can alternatively be added to the region on the substrate containing the catalyst. The polymerization reaction is allowed to proceed until the monomers are consumed, or until the reaction is terminated in some other manner.

It will be readily apparent to those of skill in the art that the foregoing synthetic method is intended to illustrate, and not restrict, the ways in which the reagents can be simultaneously reacted to form materials on a single substrate. Other synthetic methods and other modifications known to and used by those of skill in the art can also be used.

Once prepared, the array of catalysts can be screened in parallel for catalysts having useful properties by screening the following for a measurable property or properties: the substrate, the reaction in question, the product(s) resulting from the reaction or side reactions (e.g., degradation of polymers and oligomers via the Fries phenol ester rearrangement reaction). Either the entire array or, alternatively, a section thereof (e.g., a row of predefined regions) can be screened in parallel for catalysts having useful properties by, again, screening the substrate, the reaction in question, the product(s) resulting from the reaction or side reactions, for a measurable property or properties.

Accordingly, in an embodiment, the array of catalysts is synthesized on a single substrate. By synthesizing the array of catalysts on a single substrate, screening the array for catalysts having useful properties is carried out easily. Properties which can be screened for include, for example, electrical, thermal, mechanical, morphological, optical, magnetic, chemical, etc. More particularly, properties which can be screened for include, for example, molecular weight, conductivity, resistivity, thermal conductivity, anisotropy, hardness, crystallinity, optical transparency, photoemission, or other measurable properties which will be apparent to those of skill in the art.

Screening of the aforementioned properties may be accomplished by using conventional methods and devices known to and used by those of skill in the art. The arrays of the preferred embodiments of the present invention can be screened sequentially or, alternatively, they can be screened in parallel using a scanning system. Scanning systems which can be used to screen for the aforementioned properties include, but are not limited to, the following: gel permeation chromatography (GPC), high-performance liquid chromatography (HPLC), scanning Raman spectroscopy; scanning NMR spectroscopy; ultra fast photo excitation, UV-visible spectroscopy and fluorescence spectroscopy. In a preferred embodiment, fluorescence spectroscopy, HPLC and/or GPC are used as the methods for measuring the useful property or properties, namely formation of an undesired by-product that results from a Fries phenol ester rearrangement reaction.

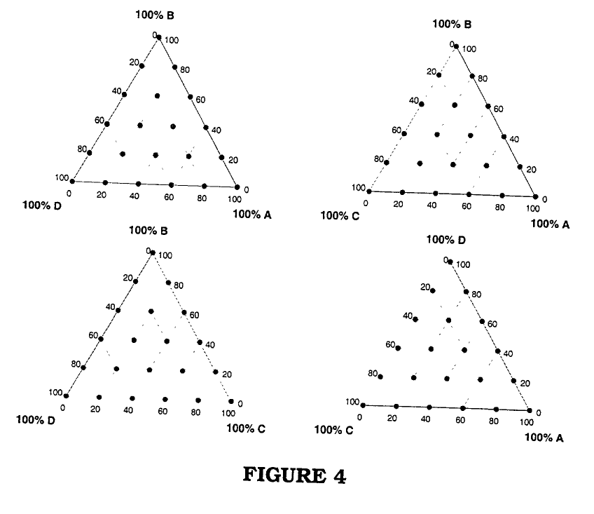

FIG. 5 shows how the data from screening can be effectively visualized in order to determine the best catalyst composition. The plot in the top left-hand panel shows the amount of Fries generated in the polycarbonate condensation reaction, across the gradient ternary mixtures of Na₂EDTA, Cs₂SO₄ and Na₂B₄0₇. The plot in the top right-hand shows the molecular weight response for the same gradient library. The effect of a co-catalyst across an entire library can be observed if a co-catalyst is added to the “Mother Library” in equal molar amounts forming a new library, commonly referred to as a “1^{st} Generation Daughter” library. Adding additional co-catalyst can form subsequent generations. Other “Sibling Libraries” can also be envisioned when adding different co-catalyst to the same Mother Library. The plots in the lower half of the figure show the effect of the addition of bathophenanthroline sodium salt, a know alkali ion chelator, to the original ternary library with respect to Fries and molecular weight formation for the polycarbonate condensation polymerization.

It will be readily apparent to those of skill in the art that the foregoing detection systems are intended to illustrate, and not restrict, the ways in which the array of material can be screened for those materials having useful properties. Other detection systems known to and used by those of skill in the art can similarly be used.

Having now generally described this invention, the same will be understood by reference to the following examples which are provided herein for purposes of illustration only and are not intended to be limiting unless otherwise specified.

### EXAMPLE 1

LiOH, CsOH and KOH stock solutions were prepared in water. The concentration of alkali metal hydroxide in each stock solution was 8×10⁴ M. A gradient array of catalysts was created by adding an amount of stock solution to each of twenty-one wells on a 96 well microtiter plate according to FIG. 2. The addition was performed using a Hamilton robot. Once the ternary library plate is made, the 96 well glass plate is loaded with 25 μL/well of the catalyst solutions, using an automatic pipetter. Another 25 μL/well of a co-catalyst aqueous solution (0.001 M) is added on top of the catalyst solutions. The plate is then placed in a vacuum oven at approximately 50° C. for 45-60 min to remove the solvent (water). 200 μL/well of an acetone solution of diphenylcarbonate (DPC) and BPA (0.5 mM in BPA and 0.6 mM in DPC) are then added using an automatic pipetter. The plate is again placed in the vacuum oven to remove the acetone. After co-solvent evaporation the reactor plate is placed in the reactor under a steady flow of nitrogen. The heating profile includes a ramp to 180° C., soaking period of 20 minutes at this temperature, then heating to 240° C., followed by another soaking period of 20 minutes at this temperature. There is a final ramp to 295° C. and a soaking period of 20 minutes at this final temperature. The plate is then quickly cooled to room temperature, still under nitrogen, to quench the reaction.

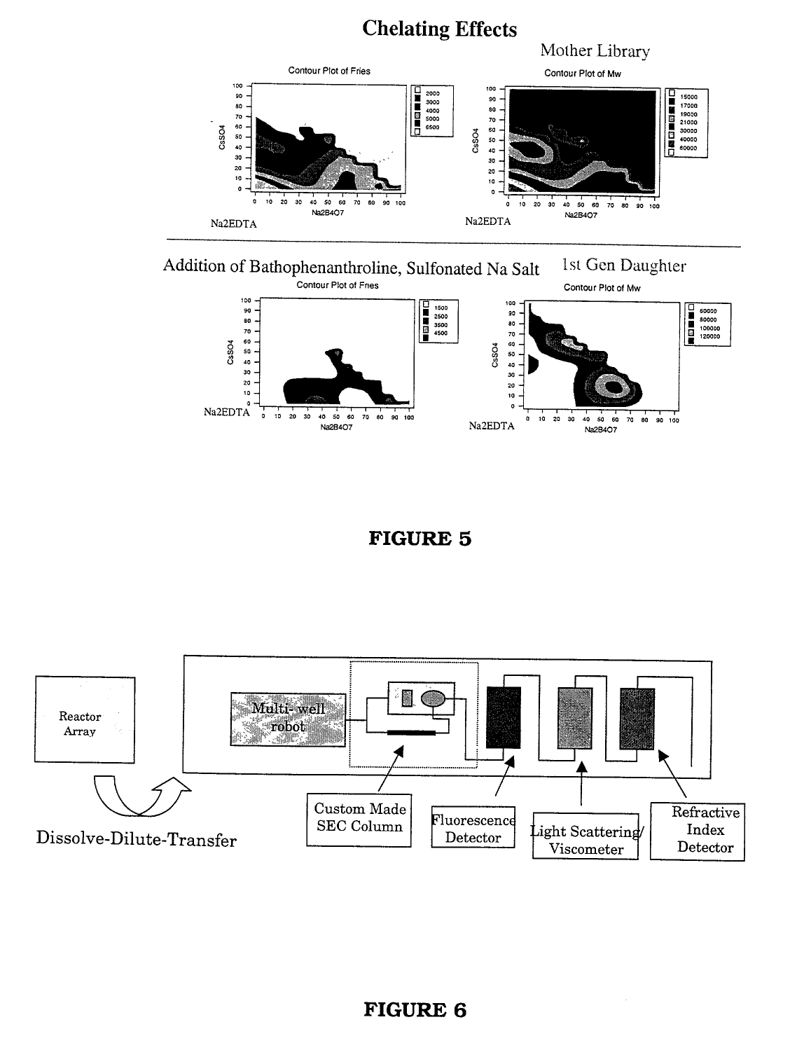

After quenching the polymer array is dissolved in the appropriate solvent, chloroform in this case, by adding the 300-600 μl of the solvent along with stir bars and allowing to stir covered for at least 1.5 hours. After dissolving, 300 μl of the polymer solution is transferred to the appropriate autosampler vessel and further diluted with 300-600 μl of solvent. The polymer array is then analyzed according to catalyst composition, for molecular weight build and Fries rearrangement using a multi-detector liquid chromatography system as shown in FIG. 6.

From the foregoing description, one skilled in the art can easily ascertain the essential characteristics of this invention, and without departing from the spirit and scope thereof, can make various changes and modifications of the invention to adapt it to various uses and conditions without undue experimentation. All patents, patent applications and publications cited herein are incorporated by reference in their entirety.

We claim:

1. A method of making and screening an array of catalysts, said method comprising:
(a) combining a first polymerization precursor material, a second polymerization precursor material and a first catalyst in a first region on a substrate;
(b) combining a first polymerization precursor material, a second polymerization precursor material and a second catalyst in a second region on a substrate;
(c) reacting the first and second polymerization material in said first and second regions; and
(d) screening said first and second regions of said substrate for a measurable property or properties.

2. The method of claim 1, wherein first polymerization precursor material and said second polymerization precursor material react to form a polycarbonate; and
step (d) comprises screening first and second polycarbonate compositions in first and second regions.

3. The method of claim 1, wherein the first and second catalysts comprise one or more metal salts of differing stoichiometries or composition.

4. The method of claim 1, wherein the first and second catalysts comprise 3 metal salts of differing stoichiometries or composition.

5. The method of claim 1, wherein the first and second catalysts comprise 3 metal salts of differing stoichiometries or composition which are the result of three-way combinations of multiple (>3) metal salts.

6. The method as in any one of claims 3 or 4, wherein the metal salts are alkali metal salts, alkaline earth metal salts, transition metal salts or mixtures thereof.

7. The method of claim 2, wherein the step of screening comprises measuring fluorescence emission.

8. The method of claim 1, wherein step (a) comprises:
(i) delivering the first catalyst to the first region on the substrate;
(ii) delivering the first polymerization precursor material and the second polymerization precursor material to said first region on the substrate; and
step (b) comprises:
(i) delivering the second catalyst to said second region on the substrate; and
(ii) delivering the first polymerization precursor material and the second polymerization precursor material to said second region on a substrate.

9. The method of claim 8, wherein step (a) occurs before step (b).

10. The method of claim 8, wherein step (a) and step (b) are performed at the same time.

11. The method of claim 8, wherein the first polymerization precursor material and the second polymerization precursor material are delivered before the catalyst.

12. The method of claim 8, wherein the first polymerization precursor material and the second polymerization precursor material are delivered after the catalyst.

13. The method of claim 8, further comprising mixing of the first polymerization precursor material and the second polymerization precursor material prior to delivery.

14. The method of claim 8, further comprising mixing the first polymerization precursor material and the catalyst prior to being delivered.

15. The method of claim 8, further comprising mixing the second polymerization precursor material and the catalyst prior to being delivered.

16. The method of claim 8, further comprising delivering the first polymerization precursor material before the catalyst and then delivering the second polymerization precursor material.

17. The method of claim 2, wherein the first polymerization precursor material comprises a bisphenol and the second polymerization precursor material comprises a diaryl ester of carbonic acid.

18. The method of claim 17, wherein the bisphenol is bisphenol A and the second polymerization precursor material is diphenylcarbonate.

19. A method of making and screening an array of catalysts, said method comprising:
(a) combining a bisphenol compound, diaryl ester of carbonic acid and a first metal salt catalyst in a first region of a substrate;
(b) the bisphenol compound, the diaryl ester of carbonic acid and a second metal salt catalyst in a second region on a substrate;
(c) reacting a bisphenol compound and a diaryl ester of carbonic acid in said first and second regions; and
(d) screening said first and second regions of said substrate for a measurable property or properties.

20. The method of claim 19, wherein a bisphenol compound and a diaryl ester of carbonic acid react to form a polycarbonate; and
step (d) comprises screening first and second polycarbonate compositions in first and second regions.

21. The method of claim 19, wherein the first and second metal salt catalyst comprises one or more metal salts of differing stoichiometries or composition.

22. The method of claim 19, wherein the first and second metal salt catalyst comprises 3 metal salts of differing stoichiometries or composition.

23. The method of claim 19, wherein the first and second metal salt catalysts comprise all possible three-way combinations of 4 or more metal salts of differing stoichiometries or composition.

24. The method of claim 19, wherein the metal salt is an alkali metal salt, an alkaline earth metal salt, a transition metal salt or mixtures thereof.

25. The method of claim 20, wherein the step of screening comprises measuring fluorescence emission.

26. The method of claim 19, wherein step (a) comprises:
(i) delivering the first metal salt catalyst to the first region on the substrate;
(ii) delivering a bisphenol compound and a diaryl ester of carbonic acid to said first region on the substrate; and
step (b) comprises:
(i) delivering the second metal salt catalyst to said second region on the substrate; and
(ii) delivering the bisphenol compound and the diaryl ester of carbonic acid to said second region on a substrate.

27. The method of claim 26, wherein step (a) occurs before step (b).

28. The method of claim 26, wherein step (a) and step (b) are performed at the same time.

29. The method of claim 26, wherein the bisphenol compound and the diaryl ester of carbonic acid are delivered before the catalyst.

30. The method of claim 26, wherein the bisphenol compound and the diaryl ester of carbonic acid are delivered after the catalyst.

31. The method of claim 26, further comprising mixing the bisphenol compound and the diaryl ester of carbonic acid prior to delivery.

32. The method of claim 26, further comprising mixing the bisphenol compound and the catalyst prior to being delivered.

33. The method of claim 26, further comprising mixing the diaryl ester of carbonic acid and the catalyst prior to being delivered.

34. The method of claim 26, further comprising delivering the bisphenol compound before the catalyst and then delivering the diaryl ester of carbonic acid.

35. The method of claim 26, further comprising delivering the diaryl ester of carbonic acid before the catalyst and then delivering the bisphenol compound.

36. A polycarbonate article produced by the method of claim 1.

37. A polycarbonate article produced by the method of claim 20.

38. The method of claim 1, wherein the substrate forms a rigid support.

39. The method of claim 26, wherein said bisphenol compound is bisphenol A and said diaryl ester of carbonic acid is diphenylcarbonate.

40. The method of claim 2, wherein the step of screening comprises measuring molecular weight.

41. The method of claim 20, wherein the step of screening comprises measuring molecular weight.

42. The method of claim 1, wherein the first and second catalysts further comprise an organic co-catalyst.

43. The method of claim 42, wherein said organic co-catalyst is tetramethyl ammonium hydroxide.

44. The method of claim 19, wherein the first and second metal salt catalysts further comprise an organic co-catalyst.

45. The method of claim 44, wherein said organic co-catalyst is tetramethyl ammonium hydroxide.
